(19) United States
(12) Patent Application Publication
(10) Pub. No.: US 2017/0008491 A1
(43) Pub. Date: Jan. 12, 2017

(54) Glass Break Detector

(71) Applicant: Todd Bunting, Lexington, SC (US)

(72) Inventor: Todd Bunting, Lexington, SC (US)

(21) Appl. No.: 15/207,501

(22) Filed: Jul. 11, 2016

Related U.S. Application Data
(63) Continuation-in-part of application No. 29/488,585, filed on Apr. 21, 2014, now Pat. No. D761145.
Application No. 29/488,585 is a continuation-in-part of application No. 13/052,085, filed on Mar. 20, 2011, now abandoned.

(51) Int. Cl. B60R 25/34

(52) U.S. Cl. CPC B60R 25/34

(57) ABSTRACT

In an embodiment of the invention, an apparatus comprises: a glass break detector comprising a first circuit board to detect breaking of glass; and a second circuit configured to transmit a signal or other data indicating a breaking of glass.

### CROSS-REFERENCE(S) TO RELATED APPLICATIONS

This application is a continuation-in-part of U.S. application Ser. No. 29/488,585 which was filed on 21 Apr. 2014 and which is a continuation-in-part of U.S. application Ser. No. 13/052,085 which was filed on 30 Mar. 2011. U.S. application Ser. Nos. 29/488,585 and 13/052,085 are hereby fully incorporated herein by reference.

### FIELD

Embodiments of the invention relate generally to glass break detectors.

### DESCRIPTION OF RELATED ART

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against this present disclosure.

As the economy declines, property crimes tend to rise. In particular, vehicle break-ins have become a major problem faced everyday throughout the United States. Both residential and commercial neighborhoods are frequently targeted by both professional and amateur smash-and-grab vehicle vandals. While factory car alarms are ubiquitous, vehicle smash-and-grab vandals have discovered that they often can break into a parked vehicle and take items that they want without being detected by simply breaking out a window glass of a vehicle, crawling inside, taking the items that they want, and crawling back out. In fact many smash-and-grab vandals will not even open an unlocked door to prevent alarms from sounding but will break out a glass of the vehicle and proceed as described above.

Compounding the problems of a vehicle smash-and-grab theft is that many vehicle owners, particularly those in larger cities and apartment complexes lack either a garage or a garage space as parking spaces for their vehicles. Consequently, many vehicles are parked on the street or in open and unsecured lots. This creates a problem with standard vehicle alarms in that they are only effective if they are close enough to wake a vehicle owner. But, in many urban settings, vehicle alarms go off so often that some people do not even react if they hear an alarm. Thus, even if a standard vehicle security system detects a vandal and sounds an alarm, that alarm is usually ignored and as such, the alarm will not directly inform the owner of the vehicle that his or her vehicle has been broken into.

Unfortunately neighborhoods targeted by smash-and-grab vandals tend to be ones having higher than average crime rates. Therefore, many vehicle owners have installed home security systems that sound alarms, both silent and audible, when a security incident such as smoke, fire, home break-in or other problem is detected. Glass breakage has also become a problem in homes. Over the years numerous methods of detecting glass breakage have been used. For example, the frequency of a breaking glass will activate some sound sensors. Other broken glass sensors use have used infrared, ultrasound, or microwaves to detect spatial changes in the area being monitored, such as when a glass window opens or breaks. In such systems, a quiescent state exists in the return of energy. When that state changes, the change of state is attributed to a broken glass (or a door or window opening) and an alarm sounds.

Over the years, home security systems have evolved into highly sophisticated devices that can be monitored by dedicated security agencies or by the police. After detection of a possible security event, the monitoring agency or police performs a security check of the premises. However, that level of monitoring has generally not been applied to protect against vehicle smash-and-grab thefts. Thus vehicles have remained at least somewhat vulnerable.

While the above-noted conventional systems are suited for their intended purpose(s), there is a continuing need for a reliable security system.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF DRAWINGS

Non-limiting and non-exhaustive embodiments of the invention are described with reference to the following figures, wherein like reference numerals refer to like parts throughout the various views unless otherwise specified.

It is to be noted, however, that the appended drawings illustrate only typical embodiments of this invention and are therefore not to be considered limiting of its scope, for the invention may admit to other equally effective embodiments.

FIG. 1 is an illustration of a glass break detector, in accordance with an embodiment of the invention.

FIG. 2 is an illustration of a glass break detector comprising a unit top cover, unit base, and clamp, in accordance with an embodiment of the invention.

FIG. 3 is an illustration of a glass break detector comprising a unit top cover and various components, in accordance with an embodiment of the invention.

FIG. 4 is an illustration of a glass break detector comprising a unit base and various components, in accordance with an embodiment of the invention.

FIG. 5 is a circuit for performing glass break detection in a glass break detector, in accordance with an embodiment of the invention.

FIG. 6 is an illustration of a top elevational view of a glass break detector, in accordance with an embodiment of the invention.

FIG. 7 is an illustration of a front elevational view of a glass break detector, in accordance with an embodiment of the invention.

FIG. 8 is an illustration of a side elevational view of a glass break detector, in accordance with an embodiment of the invention.

FIG. 9 is an illustration of a side cross-sectional elevational view of a glass break detector, in accordance with an embodiment of the invention.

FIG. 10 is an illustration of a top elevational view of a glass break detector, in accordance with an embodiment of the invention.

FIG. 11 is an illustration of a front elevational view of a glass break detector, in accordance with an embodiment of the invention.

FIG. 12 is an illustration of a side elevational view of a glass break detector, in accordance with an embodiment of the invention.

FIG. 13 is an illustration of a side cross-sectional elevational view of a glass break detector, in accordance with an embodiment of the invention.

FIG. 14 is an illustration of a top elevational view of a glass break detector, in accordance with an embodiment of the invention.

FIG. 15 is an illustration of a front elevational view of a glass break detector, in accordance with an embodiment of the invention.

FIG. 16 is an illustration of a side elevational view of a glass break detector, in accordance with an embodiment of the invention.

### DETAILED DESCRIPTION

In the following detailed description, for purposes of explanation, numerous specific details are set forth to provide a thorough understanding of the various embodiments of the present invention. Those of ordinary skill in the art will realize that these various embodiments of the present invention are illustrative only and are not intended to be limiting in any way. Other embodiments of the present invention will readily suggest themselves to such skilled persons having the benefit of this disclosure.

In addition, for clarity purposes, not all of the routine features of the embodiments described herein are shown or described. One of ordinary skill in the art would readily appreciate that in the development of any such actual implementation, numerous implementation-specific decisions may be required to achieve specific design objectives. These design objectives will vary from one implementation to another and from one developer to another. Moreover, it will be appreciated that such a development effort might be complex and time-consuming but would nevertheless be a routine engineering undertaking for those of ordinary skill in the art having the benefit of this disclosure. The various embodiments disclosed herein are not intended to limit the scope and spirit of the herein disclosure.

Preferred embodiments for carrying out the principles of the present invention are described herein with reference to the drawings. However, the present invention is not limited to the specifically described and illustrated embodiments. A person skilled in the art will appreciate that many other embodiments are possible without deviating from the basic concept of the invention. Therefore, the principles of the present invention extend to any work that falls within the scope of the appended claims.

As used herein, the terms “a” and “an” herein do not denote a limitation of quantity, but rather denote the presence of at least one of the referenced items.

It is to be also noted that the appended drawings illustrate only typical embodiments of this invention and are therefore not to be considered limiting of its scope, for the present invention may admit to other equally effective embodiments.

Embodiments of the invention advantageously provide the various needs that are mentioned below. There is a need for a technique of sensing vehicle glass breakage in such a manner that a home owner is informed that his (or her) vehicle is being broken into. There is also a need for a technique of using a home security system to inform a vehicle owner that his (or her) vehicle has been broken into. There is also a need for a technique of using a home security system to inform a monitoring agency or police department that a smash-and-gab vandal has broken into a vehicle by breaking glass. Other advantages that can be provided by an embodiment of the invention will become apparent based on the discussion provided herein.

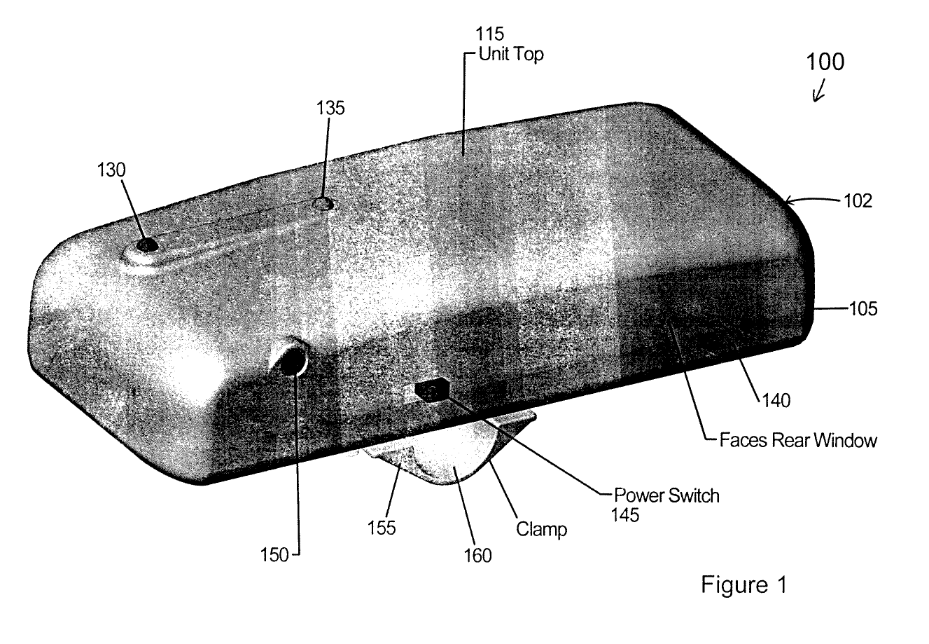

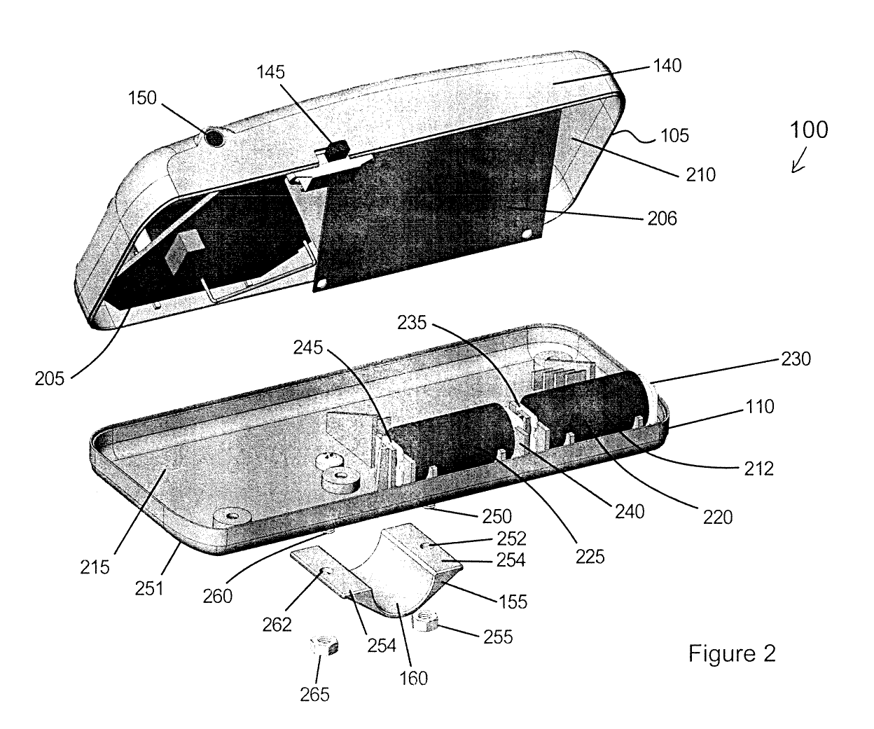

FIG. 1 is an illustration of a glass break detector 100, in accordance with an embodiment of the invention. The detector 100 comprises a housing 102. The housing 102 comprises a unit top cover 105 and a unit base 110. The unit top cover 105 (FIG. 2) is removably attached (removably coupled) to the unit base 110. Two components are removably attached (or removably coupled or removably secured) means that two different components can be attached together or detached apart. The housing 102 is configured to contain the various components of the glass break detector 100. For example, the housing 102 contains various components of the glass break detector 100 such as a microphone, circuit boards, components on or associated with the circuit boards, wiring and/or electrical paths, a power source such as, for example, one or more batteries, and power source terminals such as, for example, battery terminals.

The top cover 105 comprises a top surface 115 (or unit top 115). In an embodiment of the invention, at least two lights 130 and 135 are on the top surface 115.

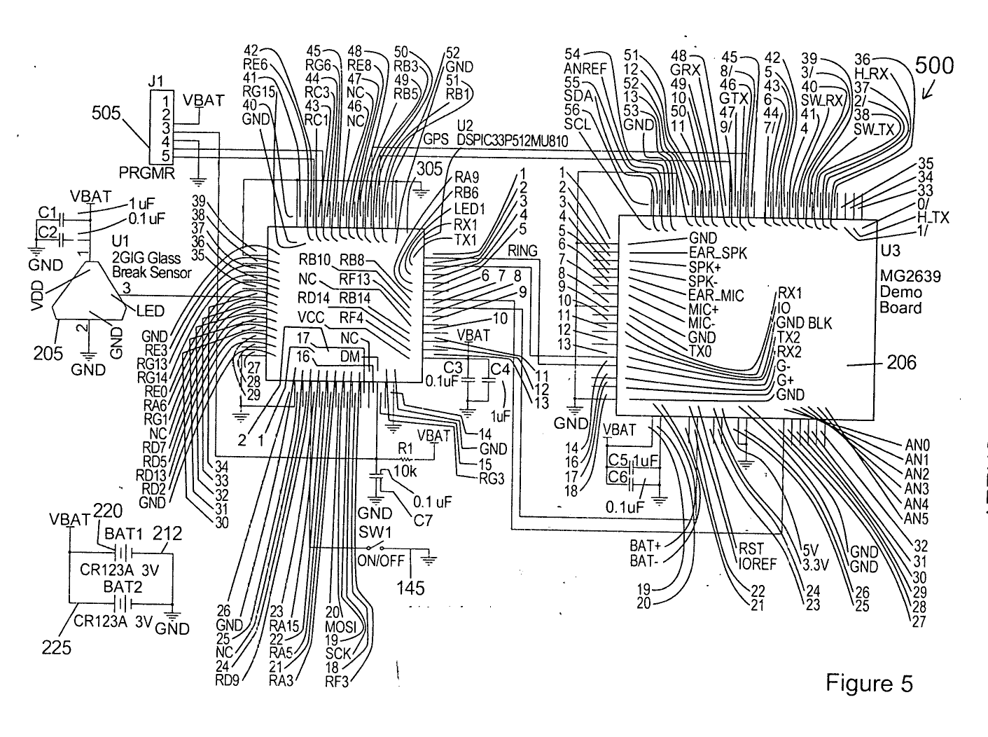

The top cover 105 also comprises a side surface 140. For example, the side surface 140 faces a rear window of a car. In an embodiment of the invention, a power switch 145 and a microphone 150 are on the side surface 140. The power switch 145 turns the circuitry (e.g., circuitry 500 in FIG. 5) in the detector 100 in an on state and in an off state. The microphone 150 receives and detects audio from the interior of a car. For example, the microphone 150 receives and detects the sound of a glass that is being broken. For example, the sound and/or frequency of a breaking glass will be detected by the microphone 150 and activate the detector in the circuit 500 in glass break detector 100 in order to indicate that a glass break has been detected.

The glass break detector 100 also includes a clamp 155 that is coupled to the unit base 110. The clamp 155 includes a curved surface 160 that forms an opening. The armature of a rear view mirror (in a car) can be disposed in the opening of the curved surface 160 so that the clamp 155 removably secures the housing 102 to an interior of a car such as, for example, the clamp 155 removably securing the housing 102 to the armature of a rear view mirror of the car.

FIG. 2 is an illustration of the glass break detector 100 comprising a unit top cover 105, a unit base 110, and a clamp 155, in accordance with an embodiment of the invention. FIG. 2 shows the various parts of the glass break detector 100 as being separated.

In an embodiment of the invention, a first circuit board 205 and second circuit board 206 are both disposed within an opening 210 of the unit top cover 105 and are both removably coupled to the top cover 105. The microphone 150 is communicatively coupled to and electrically coupled to the first circuit board 205. The first circuit board 205 comprises components that perform an algorithm that determines if an audio signal that is received by the microphone 150 indicates a sound of a breaking glass. The first circuit board 205 comprises components that are capable of performing RF (radio frequency) communications with a main alarm panel in a house or a building. The first circuit board 205 comprises the lights 130 and 135 to indicate an acquisition of communications with the main alarm panel or a loss of communications with the main alarm panel, respectively. The lights 130 and 135 may be, for example, light emitting diodes (LEDs). As an example, the main alarm panel is the GC3 Security & Control Panel which is disclosed in the link http://2gig.com/products/control-panels-keypads/gc3-panel/.

The second circuit board 206 comprises components that are capable of performing cellular communication or wireless transmission so that the components transmit a text message(s) or other data to one or more destination devices such as, for example, mobile phones with one or more mobile phone numbers. Therefore, the second circuit board 206 will include transmitters or transceivers that can perform conventional wireless transmission to at least one remote destination device such as, for example, a mobile phone or cellular phone or a computing device.

The unit base 110 serves as a cover for a power source 212 such as, for example, one or more batteries. For example, a power source 212 such as, e.g., at least one battery, is disposed in an interior surface 215 of the unit base 110. As an example, the power source 212 comprises at least one battery such as, e.g., the batteries 220 and 225. The battery 220 is electrically coupled to the terminals 230 and 235, while the battery 225 is electrically coupled to the terminals 240 and 245. The terminals 230, 235, 240, and 245 are physically connected to the interior surface 215 are also electrically coupled to the second circuit board 206 (or, alternatively, are electrically coupled to the first circuit board 205).

The clamp 155 may be removably coupled to the unit base 110 by a suitable attachment mechanism. For example, this attachment mechanism comprises a first screw 250 on a bottom outer surface 251 of the unit base 110 and that is inserted to a hole 252 on a first side portion 254 of the clamp 155 and a first screw component 255 is threadably coupled to the first screw 250 so that the first screw 250 is securely attached through the first hole 252. The attachment mechanism may also comprise a second screw 250 on the bottom outer surface 251 of the unit base 110 and that is inserted to a second hole 262 on a second side portion 264 of the clamp 155 and a second screw component 265 is threadably coupled to the second screw 260 so that the second screw 260 is securely attached through the second hole 262. The curved surface 160 is between and below the first side portion 254 and second side portion 264 of the clamp 155.

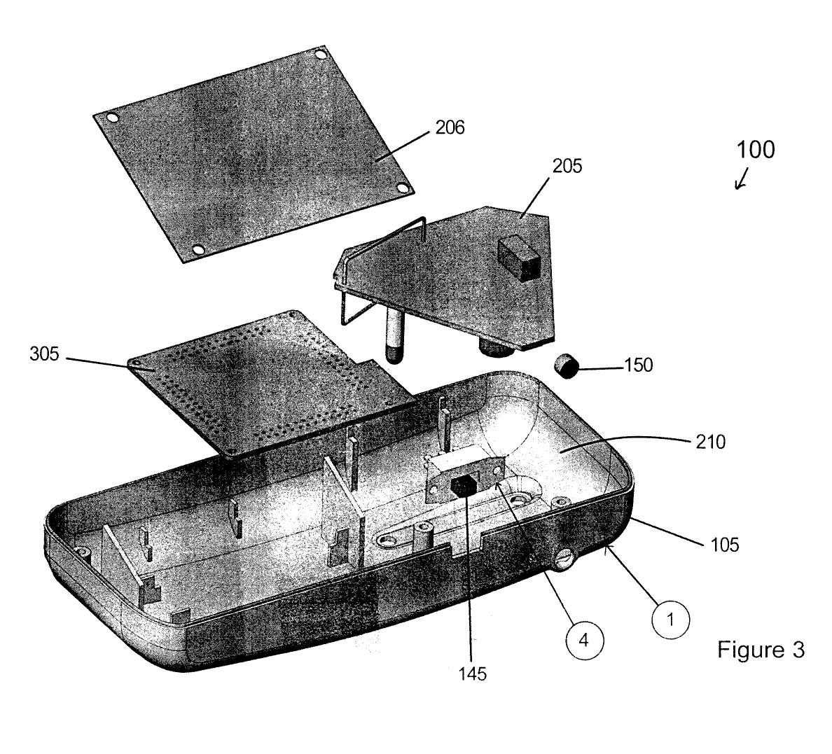

FIG. 3 is an illustration of the glass break detector 100 comprising a unit top cover 105 and various components, in accordance with an embodiment of the invention. FIG. 3 shows the various parts of the glass break detector 100 as being separated. A third circuit board 305 is also disposed within the opening 210 and removably coupled to the unit top cover 105. The third circuit board 305 comprises components that manages and that permits communication between the components in the first circuit board 205 and the components in the second circuit board 206.

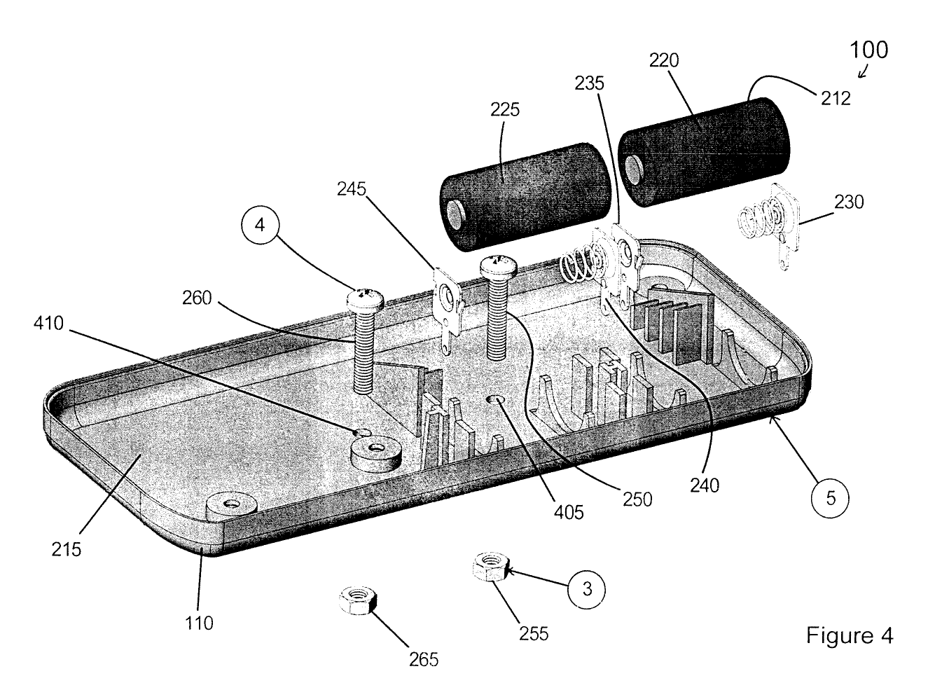

FIG. 4 is an illustration of a glass break detector 100 comprising a unit base 110 and various components, in accordance with an embodiment of the invention. FIG. 4 shows the various parts of the glass break detector 100 as being separated. The screws 250 and 260 are removably inserted into the holes 405 and 410, respectively, in the inner surface 215 of the unit base 110 and are threadably received by the screw components 255 and 265, respectively.

FIG. 5 is a circuit 500 for performing glass break detection in a glass break detector 100, in accordance with an embodiment of the invention. The third circuit board 305 is coupled to a receptacle 505 that connects the glass break detector 100 to a computer (e.g., a personal computer) that can load a program(s) to components in the third circuit board 305.

As an example, the first circuit board 205 comprises components in the product Glass Break Detector (GB1) which is manufactured by 2GIG and is disclosed in the link http://2gig.com/products/sensors/glass-break-detector.

As an example, the third circuit board 205 comprises components in a 100-pin TQFP PT MCU Card product, identified by Model PIC24FJ128GA310 from MikroElectronika and is disclosed in the link http://www.mikroe.com/easypic-fusion/mcu-cards/.

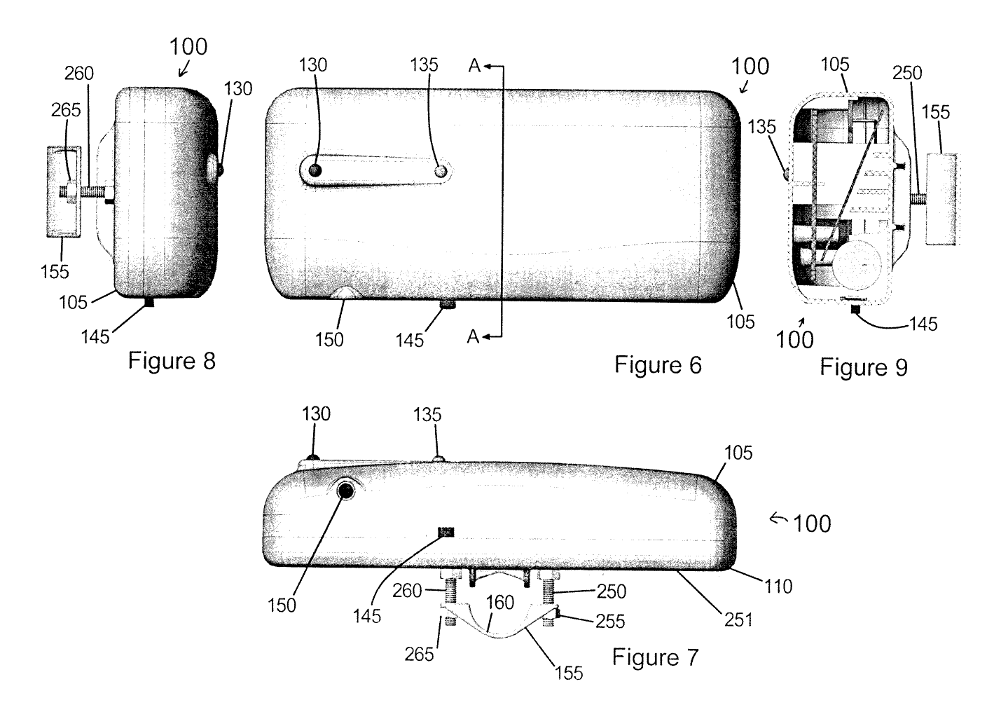

FIG. 6 is an illustration of a top elevational view of a glass break detector 100, in accordance with an embodiment of the invention.

FIG. 7 is an illustration of a front elevational view of a glass break detector 100, in accordance with an embodiment of the invention.

FIG. 8 is an illustration of a side elevational view of a glass break detector 100, in accordance with an embodiment of the invention.

FIG. 9 is an illustration of a side cross-sectional elevational view of a glass break detector 100, in accordance with an embodiment of the invention. This cross-sectional view is seen through arrows A-A as shown in FIG. 6.

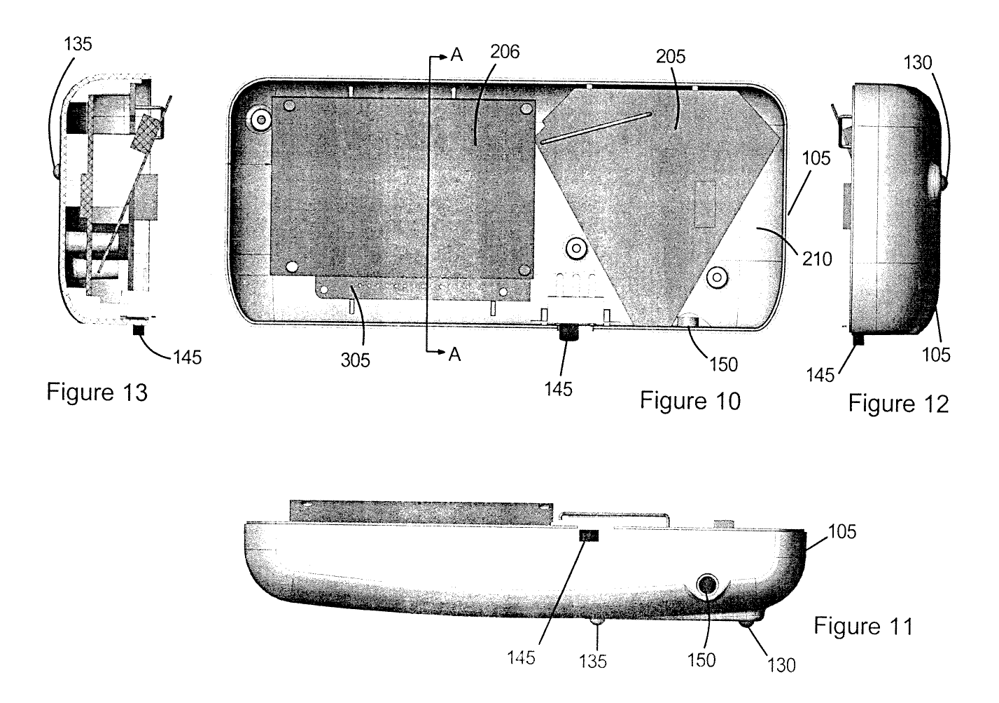

FIG. 10 is an illustration of a top elevational view of a glass break detector 100, in accordance with an embodiment of the invention. The circuit boards 205, 206, and 305 are shown as disposed in the opening 210 of the unit top cover 105.

FIG. 11 is an illustration of a front elevational view of a glass break detector 100, in accordance with an embodiment of the invention.

FIG. 12 is an illustration of a side elevational view of a glass break detector 100, in accordance with an embodiment of the invention.

FIG. 13 is an illustration of a side cross-sectional elevational view of a glass break detector 100, in accordance with an embodiment of the invention. This cross-sectional view is seen through arrows A-A as shown in FIG. 10.

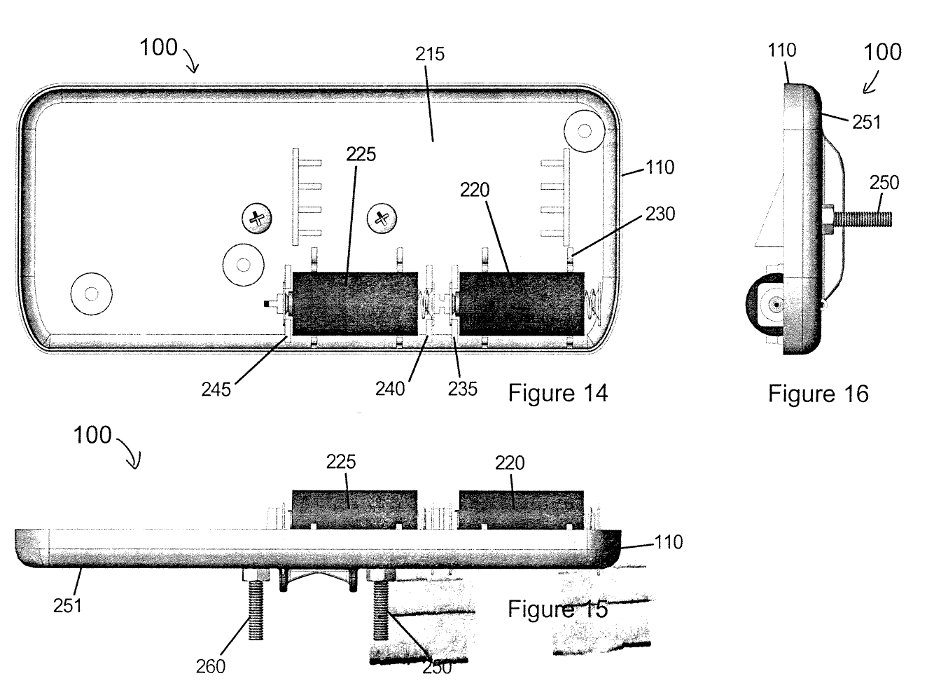

FIG. 14 is an illustration of a top elevational view of a glass break detector 100, in accordance with an embodiment of the invention. The batteries 220 and 225 are shown as disposed on the interior surface 215 of the unit base 110.

FIG. 15 is an illustration of a front elevational view of a glass break detector 100, in accordance with an embodiment of the invention.

FIG. 16 is an illustration of a side elevational view of a glass break detector 100, in accordance with an embodiment of the invention.

When the sensor formed in the first circuit board 205 detects a glass breakage, such as by a smash-and-grab vandal or possibly a tree branch or other object, the sensor in the board 205 sends a signal to the second circuit board 206 which has a transmitter or transceiver that sends a signal to a remote device to indicate that a glass breakage has occurred. The glass breakage sensor in the second circuit board 205 may alternatively use the following wireless technologies such as, for example, ultrasonic, IR, microwave, acoustic, or any other appropriate technology. Therefore, if the first circuit board detects breaking of glass, the second circuit board will transmit a signal or other data to indicate the breaking of glass.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless.

It is also within the scope of the present invention to implement a program or code that can be stored in a machine-readable or computer-readable medium to permit a computer to perform any of the inventive techniques described above, or a program or code that can be stored in an article of manufacture that includes a computer readable medium on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. An apparatus, comprising:
a glass break detector comprising a first circuit board to detect breaking of glass; and
a second circuit configured to transmit a signal or other data indicating a breaking of glass.
